(19) United States
(12) Patent Application Publication
(10) Pub. No.: US 2012/0284631 A1
(43) Pub. Date: Nov. 8, 2012

(54) METHODS TO ADAPT USER INTERFACES AND INPUT CONTROLS

(76) Inventors: German Lancioni, Cordoba (AR); Mario L. Bertogna, Cordoba (AR); Pablo R. Passera, Alta Gracia (AR)

(21) Appl. No.: 13/099,066

(22) Filed: May 2, 2011

(51) Int. Cl. G06F 3/01

(52) U.S. Cl. 715/744

(57) ABSTRACT

Methods for generating graphical user interfaces are presented. In one embodiment, a method includes determining device properties associated with a device executing an application and generating a concrete graphical user interface (CUI) based at least on the device properties and an abstract user interface (AUI) of the application. The method includes displaying the CUI on the device and determining a change in the device properties. In one embodiment, the method further includes generating, if necessary, a different CUI based at least on updated device properties and the same AUI of the application.

### FIELD OF THE INVENTION

Embodiments of the invention relate to generating computer user interfaces, in particular, to generating computer user interfaces for multiple form factors.

### BACKGROUND OF THE INVENTION

Generally, graphical user interfaces are redesigned and recreated to deploy a software application to multiple platforms. In most cases, a graphical user interface coupled with input controls are developed again for each different device, for example, a notebook, a NetBook, a smart phone, a mobile internet device (MID), a smart TV, etc.

The effort to adapt an application to multiple devices incurs additional development time/cost. Currently, Java SDK (e.g., J2ME) is compatible with different devices simply by auto-sizing all widgets in one specific screen. The solution fails if widgets (that fit into a page on a larger device) cannot fit into one screen page on a smaller device. As a result, developers may have to re-design a new graphical user interface for each device.

### BRIEF DESCRIPTION OF THE DRAWINGS

Embodiments of the present invention will be understood more fully from the detailed description given below and from the accompanying drawings of various embodiments of the invention, which, however, should not be taken to limit the invention to the specific embodiments, but are for explanation and understanding only.

FIG. 1 is a flow diagram of one embodiment of a process to analyze a graphical user interface design and to generate a concrete graphical user interface.

FIG. 2 is a flow diagram of one embodiment of a system to generate a concrete graphical user interface.

FIG. 3 is a flow diagram of one embodiment of a process to generate a concrete graphical user interface.

FIG. 4 illustrates a computer system for use with one embodiment of the present invention.

FIG. 5 illustrates a point-to-point computer system for use with one embodiment of the invention.

### DETAILED DESCRIPTION OF THE INVENTION

Methods for generating graphical user interfaces are presented. In one embodiment, a method includes determining device properties associated with a device executing an application and generating a concrete graphical user interface (CUI) based at least on the device properties and an abstract user interface (AUI) of the application. The method includes displaying the CUI on the device and determining a change in the device properties. In one embodiment, the method further includes generating, if necessary, a different CUI based at least on updated device properties and the same AUI of the application.

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of present invention also relate to apparatuses for performing the operations herein. Some apparatuses may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, embodiments of the present invention are not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

The method and apparatus described herein are for generating graphical user interfaces for applications on multi form-factors. The method and apparatus are primarily discussed in reference to multi-core processor computer systems. However, the method and apparatus for generating graphical user interfaces are not so limited, as they may be implemented on or in association with any integrated circuit device or system, such as cell phones, personal digital assistants, tablets, embedded controllers, mobile platforms, desktop platforms, and server platforms, as well as in conjunction with other resources.

### Overview

Methods for generating graphical user interfaces are presented. In one embodiment, a method includes determining device properties associated with a device executing an application and generating a concrete graphical user interface (CUI) based at least on the device properties and an abstract user interface (AUI) of the application. The method includes displaying the CUI on the device and determining a change in the device properties. In one embodiment, the method further includes generating, if necessary, a different CUI based at least on updated device properties and the same AUI of the application.

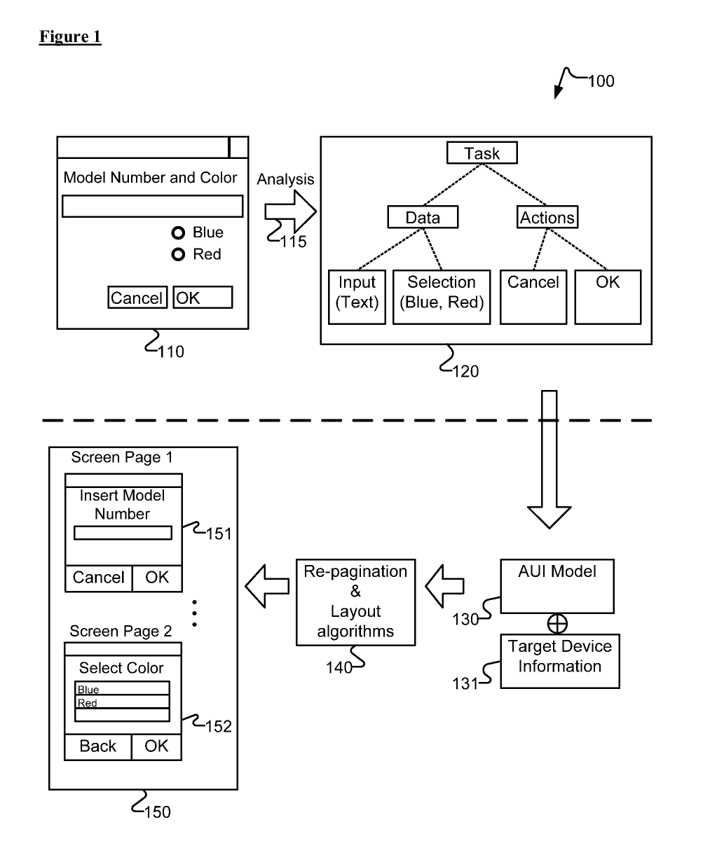

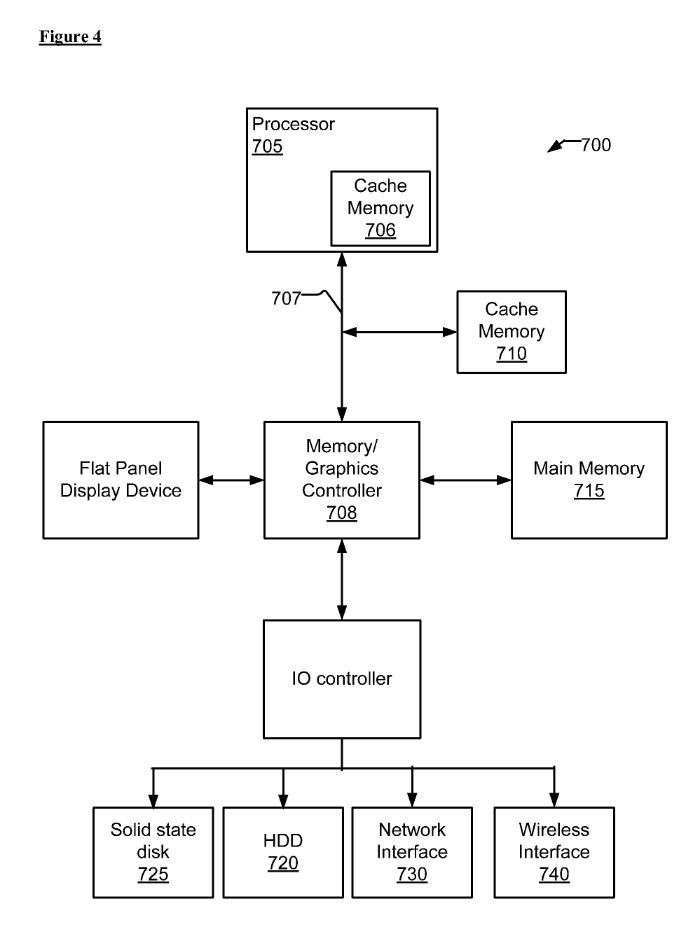

FIG. 1 is a flow diagram of one embodiment of a process to analyze a graphical user interface design and to generate a concrete graphical user interface. The process is performed by processing logic that may comprise hardware (circuitry, dedicated logic, etc.), software (such as one that is run on a general purpose computer system or a dedicated machine), or a combination of both. In one embodiment, the process is performed by a computer system with respect to FIG. 4.

### Generation of AUI

Referring to FIG. 1, in one embodiment, the process enables automatic adaptation of graphical user interfaces by detecting device information and by rendering a GUI based in part on an algorithm (e.g., re-pagination/layout module 140). In one embodiment, a developer or a programmer creates CUI 110 (e.g., Glade, Qt UI, etc.). In one embodiment, CUI 110 is a Glade XML file in which widgets are defined with the GTK+ syntax. CUI 110 includes a text input for users to input a model number and two radio buttons for users to select a color option. CUI 110 also includes a set of control buttons (“cancel” and “OK”) to confirm user inputs.

In one embodiment, processing logic generates AUI 120 (e.g., AUI in an XML format) from CUI 110, based at least in part on other information.

In one embodiment, AUI 120 is created to represent actions and is in accordance with a custom specification. Examples of actions include the abstraction of widgets, such as, for example, buttons, labels, images, videos, sliders, etc. In one embodiment, an abstract user interface (AUI) is generated in the forms of task models in accordance with an AUI language. The AUI follows a specification based on task oriented models. Widgets are represented as generic tasks, conserving their context and implicit attributes, such as, for example, relationships, priorities, groups, and mandatory sizes, if required. For example, AUI 120 comprises tasks to receive a text input and a selection input. AUI 120 also comprises actions from users (“cancel” or “ok”).

In one embodiment, generation of AUI 120 is performed during design time of an application. For example, a developer provides an existing CUI. Processing logic performs analysis transform the CUI (e.g., CUI 110) into an AUI (e.g., AUI 120).

### Generation of CUI

In one embodiment, processing logic gathers device information or device properties associated with the device executing the application. In one embodiment, target device information 131 contains specific information about the target device. In one embodiment, the information includes the type of the device, the screen size, the screen resolution, the number of screens, input devices available, etc.

In one embodiment, processing logic gathers metadata about the executing device via DBus and X11.

In one embodiment, after AUI 130 is generated and target device information 131 is gathered, processing logic generates CUI 150 based on the these sources by using an algorithm (e.g., re-pagination/layout 140). In one embodiment, processing logic dynamically generates CUI 150.

In one embodiment, re-pagination/layout 140 comprises modules to perform, re-pagination (splitting pages), layout arrangement, navigation control insertion, etc. In one embodiment, processing logic receives inputs from: (1) page splitting & layout logic (e.g., XSLT file), (2) an AUI (e.g., XML file), and (3) target device information (e.g., embedded into a XSLT file). Re-pagination/layout 140 will be discussed in more detail below.

In one embodiment, target device information is embedded into a same XSLT file as the page splitting & layout logic. In one embodiment, processing logic generates a customized XSLT file based on the page splitting & layout logic and the device information. In other embodiments, the target device information is in a separate file, for example, another XSLT file.

In one embodiment, processing logic, in conjunction with execution of re-pagination/layout 140, receives tasks description in AUI 130 and generates a final CUI (e.g., CUI 150) according to limitations and capabilities of a device executing the application. In one embodiment, processing logic is a part of the device executing the application.

In one embodiment, processing logic transforms AUI 130 into CUI 150. The transformation takes into the account of widgets (available in CUI) to be used for representing tasks and characteristics thereof. In one embodiment, task characteristics relate to a minimum widget size, task priority (e.g., some tasks should be displayed in the first screen page if the application is split into multiple screen pages), grouping information (e.g., confirmation and cancellation are grouped tasks), a mandatory size (e.g., a video area is at least 50% of a total screen area), etc.

In one embodiment, processing logic generates navigation controls (e.g., “next”, “previous”, or both) if the CUI is split into multiple screen pages (multiple windows). For example, on devices with smaller screen areas, an AUI is displayed in a multi-page manner. For example, CUI 150 includes two screen pages (i.e., screen page 151 and screen page 152) instead of the only one screen page in the original CUI (i.e., CUI 110).

In one embodiment, CUI 150 is rendered and linked with methods, procedures, and functions of the application.

In one embodiment, processing logic determines the device capabilities. Processing logic determines most convenient widgets to represent actions desired. If the form factor of a device is smaller than the original user interface, processing logic split the UI and generates multiple screens with navigation controls in the final CUI for use on the smaller device (e.g., a smart phone with a smaller display).

In one embodiment, framework 100 is independent from additional services, applications, or tools to recreate a user interface for each different device. Framework 100 is applicable for an application that has been developed. Framework 100 employs the concept of AUI to represent user interfaces and surrounding logic rules (e.g., widgets group information, priorities, mandatory screen sizes, etc.). In one embodiment, framework 100 is independent from a runtime SDK. For example, AUI 130 and re-pagination/layout 140 are embedded in an application as a library or a part of the application. In one embodiment, framework 100 is used in conjunction with code in a high level computer language, including object oriented and other languages, e.g., FORTRAN, Java, C++, etc.

In one embodiment, processing logic generates CUI 150 in response to the execution of the application during runtime.

In one embodiment, framework 100 uses an AUI definition in accordance with the XML format. An element in the AUI is mapped into one or more widgets, hardware input controls, any combinations thereof according to the actual target device. For example, a push action is rendered as a soft-button on a Netbook but a hard control button on a smart phone.

In one embodiment, the AUI specification language includes approaches in, for example, UsiXML, XForms, etc. In one embodiment, the AUI specification language includes tasks, containers, instances, widgets abstraction, and properties models. The AUI specification further includes concepts and definitions, such as, for example, priority information, grouping information, sequence information, and event mappings.

In one embodiment, framework 100 is implemented in conjunction with an AUI Specification Model. According to the AUI specification model, a container is the representation of a screen page, a task is a representation of a widget. Additional metadata are included to generate a final CUI and to define some characteristics of the final CUI.

### Re-Pagination and Layout Algorithm

In one embodiment, re-pagination and layout algorithms are part of framework 100. In one embodiment, re-pagination/layout 140 parses an AUI to generate a CUI. Re-pagination/layout 140 performs the generation based on device properties, widgets, and desired behaviors that users specify. In one embodiment, re-pagination/layout 140 is composed as a XSLT parser file that generates an output (i.e., a CUI) in the XML format. In one embodiment, re-pagination/layout 140 is coded with the XSLT language to transform an AUI to a CUI, which is an unconventional use of the XSLT language.

In one embodiment, re-pagination/layout 140 uses target device metadata that is extracted from the device using an X11 interface (Linux based devices) or OS API (Windows based devices). In one embodiment, re-pagination/layout 140 includes modules to perform, for example, re-pagination, layout splitting, device information gathering, container parsing, split coordination, screen stack calculation, action parsing, group parsing, and navigation control insertion.

In one embodiment, a re-pagination module decides and moves widgets from one screen page to another screen page based on device characteristics and pre-defined preferences by developers. Layout splitting helps the repagination by creating new windows (screen pages) to accommodate widgets or by joining multiple screen pages into fewer screen pages. Layout splitting estimates how many screen pages are required for each target platform. For example, an application needs to use two screen pages if executing on a NetBook but needs to use four screen pages (windows) on a smart phone. In one embodiment, framework 100 relocates widgets on the display so the user experience is maintained through different devices.

In one embodiment, container parsing analyzes the GUI to set the locations of containers. In one embodiment, a container is similar to a widget that contains other widgets which are always managed as a unit. Container parsing also creates new containers if needed. For example, a container with three buttons (“play”, “stop” and “pause”) indicates that the three buttons are always placed together so that the design is more ease to use. Such implicit information is useful to determine during the process of splitting a screen page.

In one embodiment, split coordination operates in iterations for each new screen page created so that all widgets are placed or moved progressively. For example, if a window capacity is reached (available screen area is low or zero), a new screen page is created.

In one embodiment, stack calculation calculates the number of widgets (“actions” in the AUI specification) to be placed into the current window. Stack calculation is based on priority information and a screen percentage calculation that determines the remaining screen area available. The output of stack calculation is useful for action parsing and group parsing.

In one embodiment, action parsing is one of the final modules that transform an abstract action into one or more widgets in the CUI by selecting most suitable widgets based on the device properties. For example, an action “push” is rendered as a button on a NetBook but is rendered as a checkbox on a smart phone. In one embodiment, group parsing is one of the final modules that transform an abstract group into one or more containers in the CUI.

In one embodiment, navigation control insertion occurs if a new screen page is created after all widgets are placed into the screen page. Navigation controls are inserted so that users can navigate from one screen to another screen. In one embodiment, navigation control is implemented using “Next”/“Previous” buttons or some other approaches suitable for a good user experience. In one embodiment, navigation controls generation is invoked in response to a window splitting (re-pagination). In one embodiment, navigation controls are “next”/“previous” buttons, a drop-down menu, an index, any combinations thereof.

In one embodiment, framework 100 provides automatic graphical user interface/input adaptation for devices in different form-factors. Programmers are able to develop an application for a specific device and then execute the application on other devices without re-develop the graphical user interface/input controls.

### Change of Device Properties

In one embodiment, applications designed for larger devices are able to execute on smaller devices. The layout splitting (re-pagination) splits one window into multiple screen pages with navigation controls in a coherent manner. In one embodiment, an application is able to perform AUI-CUI transformation dynamically at runtime with communication via an inter-process communication or a remote procedure call (e.g., DBus). For example, if the screen resolution of a display is changed or if the device is connected to another display (e.g., using another monitor/projector), a system service sends a message (a signal) to the application so that the application performs adaptation of the GUI on-the-fly.

In one embodiment, input controls are automatically adapted when an application executes on a different device. Input controls are adapted such that the application utilizes various types of input controls/interfaces available, such as, for example, a mouse, a keyboard, a stylus, a touch screen, an accelerometer, a GPS module, a hard button, a soft control button, etc.

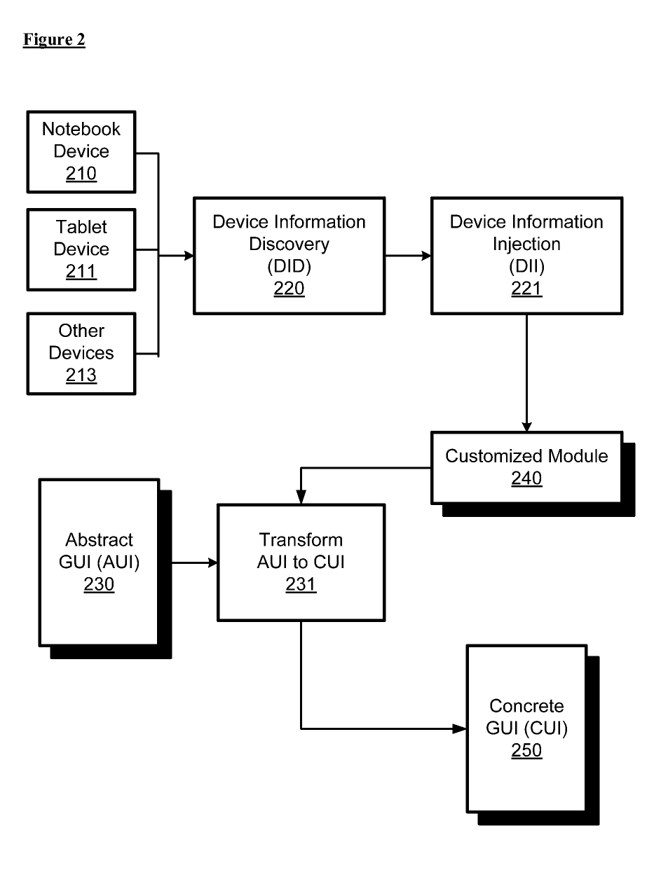

FIG. 2 is a flow diagram of one embodiment of a system to generate a concrete graphical user interface. Many related components such as buses and peripherals have not been shown to avoid obscuring the invention. Referring to FIG. 2, a system includes notebook 210, tablet 211, and other devices 213. In one embodiment, device information discovery (DID) 220, device information injection (DII) 221, and AUI-CUI transformation 231 are hardware/software modules implemented in conjunction with the devices (devices 210-213). The modules are performed by processing logic that may comprise hardware (circuitry, dedicated logic, etc.), software (such as one that is run on a general purpose computer system or a dedicated machine), or a combination of both.

Referring to FIG. 2, in one embodiment, device information is gathered by DID 220. In one embodiment, DII 221 injects the device information to re-pagination/layout algorithms. In one embodiment, customized module 240 is a XSLT module which is compiled or generated based on the device information from DII 221 and a re-pagination and layout logic module. In one embodiment, AUI-CUI transformation 231 receives AUI 230 and customized module 240 in the XSLT format to generate a final adapted CUI (e.g., CUI 250 coded as an XML file). In one embodiment, DID 220, DII 221, and AUI-CUI transformation 231 operate together as a system to perform re-pagination (splitting) and layout arrangement.

In one embodiment, a processing device (e.g., devices 210-213) includes a graphic processor which is integrated with a CPU in a chip. In other embodiments, the graphic processor and a CPU are discrete devices. In one embodiment, a graphic processor is also a processing device operable to support some processing workload from a CPU. In one embodiment, a graphic processor includes processing devices (e.g., a processor, digital signal processing units, and a microcontroller). The method and apparatus above are primarily discussed in reference to a CPU/GPU. However, the methods and apparatus are not so limited, as they may be implemented on or in association with any processing devices including a graphics processor, digital signal processing units, a microcontroller, or any combinations thereof.

In one embodiment, a computer system (e.g., devices 210-213) comprises a computer workstation, laptop, desktop, server, mainframe or any other computing device.

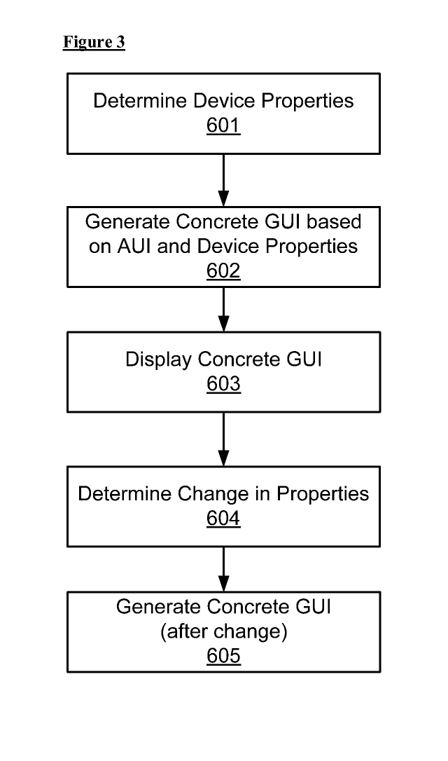

FIG. 3 is a flow diagram of one embodiment of a process to generate a concrete graphical user interface. The process is performed by processing logic that may comprise hardware (circuitry, dedicated logic, etc.), software (such as one that is run on a general purpose computer system or a dedicated machine), or a combination of both. In one embodiment, the process is performed by a computer system with respect to FIG. 4.

Referring to FIG. 3, in one embodiment, processing logic begins by determining device properties associated with a device in response to execution of an application on the device (process block 601). Processing logic gathers device information, such as, for example, a screen size, a screen resolution, inputs capabilities of the device, etc.

In one embodiment, processing logic generates a concrete graphical user interface (CUI) based at least on the device properties and an abstract user interface (AUI) of the application (process block 602). In one embodiment, processing logic determines user interface elements based on task-based elements represented in the AUI. A user interface element is also referred herein as a widget. Processing logic applies a re-pagination and layout algorithms based on the AUI and the device information. Processing logic splits a user interface window into multiple screen pages when necessary and adds navigation controls in the screen pages.

In one embodiment, processing logic calculates an estimate of the number of user interface elements in a screen page based on precedence information of each user interface element and the remaining screen page information. In one embodiment, processing logic determines whether to split a screen page into two or more screen pages. Processing logic inserts navigation controls to each screen pages. For example, the last screen page only shows a navigation control to a previous page. The last screen page does not show a navigation control to a subsequent screen.

In one embodiment, processing logic generates a CUI based on device properties including information about one or more hardware buttons. In one embodiment, processing logic generates a CUI which is capable of receiving user inputs from one or more hardware buttons and one or more soft buttons.

In one embodiment, processing logic generates and displays a final adapted CUI (process block 603). Processing logic renders and displays the final CUI on the display of a device.

In one embodiment, processing logic determines whether there is a change in device properties (process block 604). For example, processing logic monitors a system service to detect whether a change has occurred. In one embodiment, processing logic receives a message from a system service when a change has occurred.

In one embodiment, processing logic generates a different CUI based on the updated device properties and a same AUI of the application (process block 605). In one embodiment, an AUI of an application is created without knowledge of a specific device. A different CUI will be generated dynamically based on the AUI when a device begins to execute the application.

Embodiments of the invention may be implemented in a variety of electronic devices and logic circuits. Furthermore, devices or circuits that include embodiments of the invention may be included within a variety of computer systems. Embodiments of the invention may also be included in other computer system topologies and architectures.

FIG. 4, for example, illustrates a computer system in conjunction with one embodiment of the invention. Processor 705 accesses data from level 1 (L1) cache memory 706, level 2 (L2) cache memory 710, and main memory 715. In other embodiments of the invention, cache memory 706 may be a multi-level cache memory comprise of an L1 cache together with other memory such as an L2 cache within a computer system memory hierarchy and cache memory 710 are the subsequent lower level cache memory such as an L3 cache or more multi-level cache. Furthermore, in other embodiments, the computer system may have cache memory 710 as a shared cache for more than one processor core.

Processor 705 may have any number of processing cores. Other embodiments of the invention, however, may be implemented within other devices within the system or distributed throughout the system in hardware, software, or some combination thereof.

In one embodiment, graphics controller 708 is integrated with processor 705 in a chip. In other embodiment, graphics controller 708 and processor 705 are discrete devices. In one embodiment, graphic controller 708 is also a processing device operable to support some processing workload from processor 705. In one embodiment, graphics controller 708 includes a processing device (e.g., a processor, a graphics processor, digital signal processing units, and a microcontroller).

Main memory 715 may be implemented in various memory sources, such as dynamic random-access memory (DRAM), hard disk drive (HDD) 720, solid state disk 725 based on NVRAM technology, or a memory source located remotely from the computer system via network interface 730 or via wireless interface 740 containing various storage devices and technologies. The cache memory may be located either within the processor or in close proximity to the processor, such as on the processor's local bus 707. Furthermore, the cache memory may contain relatively fast memory cells, such as a six-transistor (6T) cell, or other memory cell of approximately equal or faster access speed.

Other embodiments of the invention, however, may exist in other circuits, logic units, or devices within the system of FIG. 4. Furthermore, other embodiments of the invention may be distributed throughout several circuits, logic units, or devices illustrated in FIG. 4.

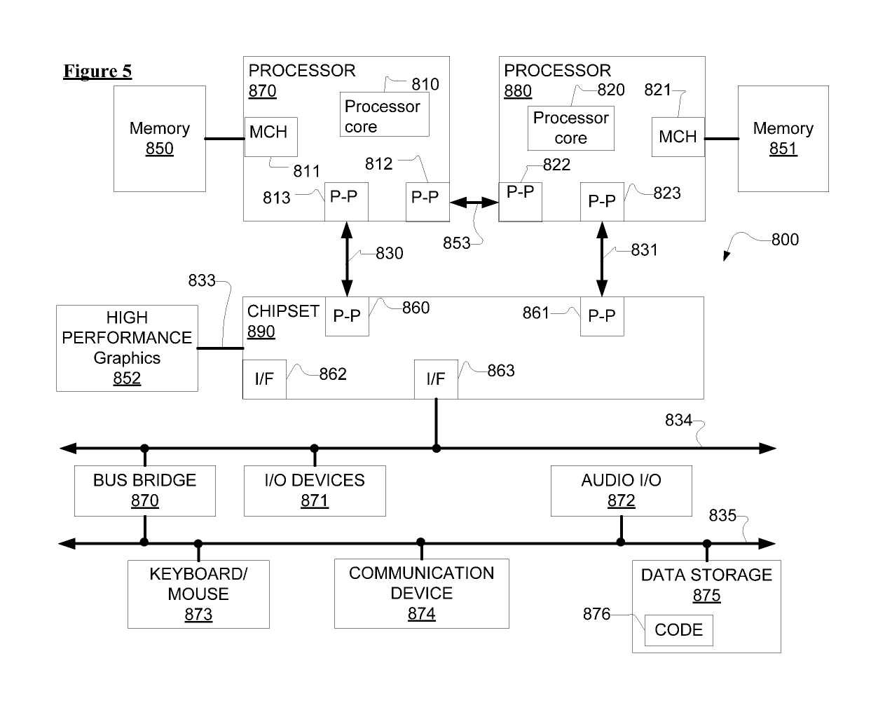

Similarly, at least one embodiment may be implemented within a point-to-point computer system. FIG. 5, for example, illustrates a computer system that is arranged in a point-to-point (PtP) configuration. In particular, FIG. 5 shows a system where processors, memory, and input/output devices are interconnected by a number of point-to-point interfaces.

The system of FIG. 5 may also include several processors, of which only two, processors 870, 880 are shown for clarity. Processors 870, 880 may each include a local memory controller hub (MCH) 811, 821 to connect with memory 850, 851. Processors 870, 880 may exchange data via a point-to-point (PtP) interface 853 using PtP interface circuits 812, 822. Processors 870, 880 may each exchange data with a chipset 890 via individual PtP interfaces 830, 831 using point to point interface circuits 813, 823, 860, 861. Chipset 890 may also exchange data with a high-performance graphics circuit 852 via a high-performance graphics interface 862. Embodiments of the invention may be coupled to computer bus (834 or 835), or within chipset 890, or within data storage 875, or within memory 850 of FIG. 5.

Other embodiments of the invention, however, may exist in other circuits, logic units, or devices within the system of FIG. 5. Furthermore, other embodiments of the invention may be distributed throughout several circuits, logic units, or devices illustrated in FIG. 5.

The invention is not limited to the embodiments described, but can be practiced with modification and alteration within the spirit and scope of the appended claims. For example, it should be appreciated that the present invention is applicable for use with all types of semiconductor integrated circuit (“IC”) chips. Examples of these IC chips include but are not limited to processors, controllers, chipset components, programmable logic arrays (PLA), memory chips, network chips, or the like. Moreover, it should be appreciated that exemplary sizes/models/values/ranges may have been given, although embodiments of the present invention are not limited to the same. As manufacturing techniques (e.g., photolithography) mature over time, it is expected that devices of smaller size could be manufactured.

Whereas many alterations and modifications of the embodiment of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

What is claimed is:

1. A method comprising:
determining, in response to execution of an application, first device properties associated with a first device;
generating a first concrete graphical user interface (CUI) based at least on the first device properties and an abstract user interface (AUI) of the application; and
displaying the first CUI on the first device for the execution of the application.

2. The method of claim 1, wherein the first device properties include information about a screen size, a resolution, and presence of non-touch screen input interfaces.

3. The method of claim 1, further comprising:
determining a change in the first device properties; and
generating, if necessary, a second concrete graphical user interface (CUI) based at least on the updated first device properties and the same AUI of the application.

4. The method of claim 1, further comprising:
determining a plurality of user interface elements based at least on a plurality of task-based elements represented in the AUI; and
performing re-pagination for the plurality of user interface elements.

5. The method of claim 1, wherein the generating of the first CUI comprises:
determining whether to split into two or more screen pages; and
inserting navigation controls to each of the two or more screen pages, wherein the last screen page is without a navigation control to a subsequent screen.

6. The method of claim 1, further comprising:
determining a plurality of user interface elements based at least on the first device properties and the AUI of the application;
determining whether to use one or more screen pages for the execution of the application based at least on the first device properties; and
determining where to display each of the plurality of user interface elements on the one or more screen pages.

7. The method of claim 1, further comprising determining to combine two or more screen pages into one screen page and to move user interface elements from the two or more screen pages into the one screen page.

8. The method of claim 1, further comprising:
determining a plurality of user interface elements based at least on the first device properties and the AUI of the application; and
calculating an estimate of the number of user interface elements in a screen page based on precedence information of each user interface element and remaining screen page information.

9. The method of claim 1, further comprising:
determining a plurality of user interface elements based at least on a plurality of task-based elements represented in the AUI;
creating a first screen page;
generating an estimate of which user interface elements to fit into the first screen page based at least on the size of the first screen page; and
determining to split into a second screen page if there is any user interface element that has not been rendered.

10. The method of claim 1, further comprising:
determining a plurality of user interface elements based at least on a plurality of task-based elements represented in the AUI; and
performing re-pagination of the user interface elements in compliance with a minimum size of each user interface element, precedence information of each user interface element, group property information of each user interface element, a mandatory size of each user interface element, or any combinations of thereof.

11. The method of claim 1, wherein the AUI is created without knowledge of a second device, wherein a different CUI will be generated dynamically based on the AUI for the second device.

12. The method of claim 1, wherein the first device properties include information about one or more hardware buttons, further comprising generating the first CUI which is capable of receiving user inputs from the one or more hardware buttons and one or more soft buttons displayed on a display of the first device.

13. The method of claim 1, further comprising generating the abstract user interface from a GUI design, wherein the generating the AUI comprises:
analyzing the GUI design for the application;
determining a plurality of task-based elements;
generating a representation of the plurality of task-based elements; and
embedding the representation into an executable binary of the application, wherein the abstract GUI is represented in a transformational language.

14. The method of claim 1, further comprising determining one or more user interface elements based at least on the AUI, wherein the plurality of user interface elements are associated with a first group identifier, wherein the user interface elements of a same group identifier are rendered as a concrete group widget.

15. An article of manufacture comprising a computer readable storage medium including data storing instructions thereon that, when accessed by a machine, cause the machine to perform a method comprising:
determining, in response to execution of an application, first device properties associated with a first device;
generating a first concrete graphical user interface (CUI) based at least on the first device properties and an abstract user interface (AUI) of the application; and
displaying the first CUI on the first device for the execution of the application.

16. The article of claim 15, wherein the method further comprises:
determining a plurality of user interface elements based at least on a plurality of task-based elements represented in the AUI; and
performing re-pagination of the user interface elements in compliance with a minimum size of each user interface element, precedence information of each user interface element, group property information of each user interface element, a mandatory size of each user interface element, or any combinations of thereof.

17. The article of claim 15, wherein the method further comprises:
determining a change in the first device properties; and
generating, if necessary, a second concrete graphical user interface (CUI) based at least on the updated first device properties and the same AUI of the application.

18. A system to execute programs, comprising:
a first device;
a first device display; and
memory to store an application to be executed on the first device, wherein the first device is operable to
determine, in response to execution of the application, first device properties associated with the first device;
generate a first concrete graphical user interface (CUI) based at least on the first device properties and an abstract user interface (AUI) of the application; and
display the first CUI on the first device display for the execution of the application.

19. The system of claim 18, wherein the first device is operable to
determine a plurality of user interface elements based at least on a plurality of task-based elements represented in the AUI; and
perform re-pagination of the user interface elements in compliance with a minimum size of each user interface element, precedence information of each user interface element, group property information of each user interface element, a mandatory size of each user interface element, or any combinations of thereof.

20. The system of claim 18, wherein the AUI is created without knowledge of a second device, wherein a different CUI will be generated dynamically based on the AUI for the second device.
